(19) United States
(12) Patent Application Publication
(10) Pub. No.: US 2012/0125519 A1
(43) Pub. Date: May 24, 2012

(54) ASSEMBLY AND METHOD FOR MANUFACTURING A GREEN RADIAL PNEUMATIC TYRE

(76) Inventor: Henk-Jan Grolleman, VC Eerbeek (NL)

(21) Appl. No.: 13/378,722

(22) PCT Filed: Jun. 22, 2010
(86) PCT No.: PCT/NL10/50385

§ 371 Date: Jan. 10, 2012

Related U.S. Application Data
(60) Provisional application No. 61/219,440, filed on Jun. 23, 2009.

(30) Foreign Application Priority Data
Jun. 23, 2009 (NL) 2003069

(51) Int. Cl. B29D 30/08

(52) U.S. Cl. 156/64; 156/350

(57) ABSTRACT

Assembly and method for manufacturing a green radial pneumatic tyre. The assembly is provided with a rotatable carcass drum for carrying a carcass with a belt/tread package for the radial pneumatic tyre and with a stitching roller unit having at least one rotatable stitching roller having a stitching tread that can be placed against the carcass and a displacement device for moving the roller radially from or towards the carcass with the belt/tread package. The stitching roller unit is provided with an individual drive mechanism for rotatingly driving the stitching tread of the stitching roller, at least without the stitching roller contacting the belt/tread package. The assembly is furthermore provided with a control device for controlling a peripheral velocity of the stitching roller, wherein the assembly comprises measuring means for determining a drive torque for driving the rotatable carcass drum or a quantity derived therefrom, and for giving a signal that is representative for the drive torque to the control device.

### BACKGROUND OF THE INVENTION

The invention relates to an assembly for manufacturing a green radial pneumatic tyre, which assembly is provided with a rotatable carcass drum for carrying a carcass with a belt/tread package for the radial pneumatic tyre and with a stitching roller unit having at least one rotatable stitching roller having a stitching tread that can be placed against the carcass and a displacement device for moving the roller radially from or towards the carcass with the belt/tread package.

The invention furthermore relates to a method for manufacturing a green radial pneumatic tyre.

Such an assembly and method are known from European patent 0.627.302. In the known assembly when manufacturing a radial pneumatic tyre, the required pressing together of the belt/tread package and a carcass with beads and side walls is realised by a stitching roller unit having at least one pair of dynamic rollers following the tyre contour that are movable in longitudinal direction with respect to the carcass drum, or by a pair of dynamic rollers following the tyre contour for stitching together the edge strips of the belt/tread package and the carcass with the side walls and at least one static roller for stitching together the central parts of the belt/tread package and the carcass.

The stitching roller unit is used in the tyre building process, particularly after the side has been turned up and/or the belt package including tread has been arranged on the carcass of the tyre to be manufactured. The stitching roller stitches said rubber components to remove air inclusions. Air inclusions are disadvantageous or even disastrous, to the quality of the tyre. The rollers are positioned so as to rotate freely and are pressed against the already rotating tyre with a certain force. After said rollers have been brought into contact with the rotating tyre, the rollers start taking over the rotary motion of the rotating tyre.

A drawback of the known stitching roller unit is that due to the use of the rollers the rubber layers of the tyre that are reinforced with (steel) cords are deformed. That means that the mutual distance of the cords can be disrupted, and/or the regular course of the cords is disrupted, and/or the pattern of the course of the cords is interrupted. In practice this phenomenon is called “waving”.

It is among others an object of the present invention to provide an assembly and a method for manufacturing a green radial pneumatic tyre wherein the occurrence of “waving” is at least reduced.

### SUMMARY OF THE INVENTION

According to a first aspect of the invention an assembly of the kind mentioned in the preamble is for that purpose characterised in that the stitching roller unit is provided with an individual drive mechanism for rotatingly driving the stitching tread of the stitching roller, at least without the stitching roller contacting the belt/tread package. The stitching roller according to the invention is provided with an individual drive mechanism for rotatingly driving the stitching tread of the stitching roller, particularly before the stitching roller contacts the belt/tread package. In this way the stitching tread can be brought into rotation prior to it contacting the belt/tread package of the carcass. Because the roller is pressed against the rotating carcass with an already rotating stitching surface, particularly when the stitching tread and the carcass in the contact position run in the same direction, it has turned out that the deformation of the rubber layers of the tyre reinforced with (steel) cords can be reduced, as a result of which the “waving” can be reduced.

Furthermore the assembly according to the invention is provided with a control device for controlling a peripheral velocity of the stitching roller, and the assembly comprises measuring means for determining the drive torque for driving the rotatable carcass drum or a quantity derived therefrom, wherein the measuring means are adapted for giving a signal that is representative for the drive torque to the control device. As a result the peripheral velocity of the stitching roller and/or the peripheral velocity of the engagement position or contact position on the carcass and/or tread can be controlled depending on a drive torque for driving the carcass drum and be set such that the underlying cord layers are not deformed or hardly so, as a result of which the “waving” phenomenon is strongly reduced or does not even occur at all anymore.

In one embodiment the assembly comprises a speedometer for determining the peripheral velocity of an engagement position on the carcass and/or the control device is adapted for calculating the peripheral velocity of the engagement position on the carcass from the number of revolutions of the carcass drum and the distance of the engagement position from the axis of rotation of the carcass drum. With these data the control device can control the peripheral velocity of the stitching roller and/or the peripheral velocity of the engagement position or contact position on the carcass and/or tread substantially to the same value, prior to the stitching roller contacting the carcass and/or the belt/tread package.

In one embodiment the control device is adapted for controlling the peripheral velocity of the stitching roller depending on the signal that is representative for the drive torque. By means of this assembly a first drive torque can be determined without the stitching roller contacting the belt/tread package. Subsequently the stitching roller is placed against the belt/tread package and a second drive torque can be determined. The control device can now regulate the peripheral velocity of the stitching roller and/or the peripheral velocity of the carcass with belt/tread package such that the difference between the first and the second drive torque becomes minimal. As a result the extra rotation moment or drive torque caused by the stitching roller pressing against the belt/tread package is minimised, as a result of which the “waving” phenomenon is strongly reduced or does not even occur at all anymore.

In one embodiment the assembly comprises a servomotor for rotatingly driving the carcass drum. The servomotor can then be used in the known way as means for determining the rotation moment or drive torque that is necessary to drive the carcass drum.

In one embodiment the drive mechanism of the stitching roller unit comprises a servomotor for driving the stitching tread, as a result of which the peripheral velocity of the stitching roller can be accurately set towards the peripheral velocity of the engagement position on the carcass.

In one embodiment the stitching roller is a dynamic roller following the tyre contour, which roller is movable in a longitudinal direction with respect to the carcass drum. Such a dynamic roller following the tyre contour can be moved in the longitudinal or axial as well as in radial direction with respect to the carcass drum for stitching the belt/tread package against the carcass with the beads and the side walls.

In one embodiment the control device is adapted for controlling a peripheral velocity of the stitching roller depending on the engagement position on the carcass with the belt/tread package. In that way the peripheral velocity of the stitching roller and/or the peripheral velocity of the engagement position or contact position on the carcass can be controlled depending on the axial or longitudinal movement of the stitching roller.

In one embodiment the stitching roller unit comprises one pair of dynamic stitching rollers following the tyre contour which rollers are movable in longitudinal direction with respect to the carcass drum, wherein each of both stitching rollers is provided with its individual drive mechanism. In that way the edge strips of the belt/tread package can be simultaneously stitched on both sides of the carcass. In one embodiment a static stitching roller, that means a roller that can exclusively be moved in radial direction for stitching the central parts of the belt/tread package and the carcass with side walls together, is furthermore provided.

In one embodiment the drive mechanism is spaced apart from the stitching roller, preferably at a side of the stitching roller that faces away from the carcass drum. In one embodiment the drive mechanism is operatively connected to the stitching roller by means of a transmission, preferably the transmission comprises a chain or belt transmission.

According to a second aspect the invention provides a method for manufacturing a green radial pneumatic tyre, comprising the following steps:
arranging a carcass on a rotatable carcass drum;
arranging a belt/tread package on the carcass;
rotatingly driving the carcass drum with the carcass with the belt/tread package thereon;
moving a stitching roller unit with a rotatable stitching roller towards the carcass with the belt/tread package;
stitching the belt/tread package against the carcass by the stitching roller while simultaneously rotatingly driving the carcass drum;
wherein the stitching roller unit is provided with a drive mechanism for rotatingly driving a tread of the stitching roller, wherein the stitching roller is rotatingly driven before the stitching roller contacts the belt/tread package, and
that a drive torque for driving the rotatable carcass drum or a quantity derived therefrom is determined, and a signal that is representative for the drive torque is given to a control device for controlling a peripheral velocity.

In one embodiment the peripheral velocity of the rotatingly driven stitching roller is set depending on a peripheral velocity of an engagement position or contact position on the carcass with the belt/tread package, where the stitching roller is about to engage or engages. This takes place in particular before the stitching roller contacts the belt/tread package.

In one embodiment the control device directs the peripheral velocity of the stitching roller and/or the peripheral velocity of the carcass with belt/tread package, at least near the engagement position, to a substantially equal value.

In one embodiment a first drive torque is determined without the stitching roller contacting the belt/tread package, a second drive torque is determined when the stitching roller presses against the belt/tread package, wherein that the control device regulates the peripheral velocity of the stitching roller and/or the peripheral velocity of the carcass with belt/tread package such, at least during pressing the stitching roller against the belt/tread package, that the difference between the first and second drive torque becomes minimal.

In one embodiment the stitching roller is a dynamic roller following the tyre contour, which roller can be moved in an axial direction with respect to the carcass drum. In one embodiment the control device sets the peripheral velocity of the stitching roller depending on the axial movement of the stitching roller with respect to the carcass drum.

According to a third aspect the invention provides a stitching roller unit suitable and intended for an assembly for manufacturing a green radial pneumatic tyre or for carrying out a method as described above.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

### SHORT DESCRIPTION OF THE DRAWINGS

The invention will be elucidated on the basis of a number of exemplary embodiments shown in the attached drawings, in which:

FIG. 1 shows a schematic view of a stitching roller unit at a carcass drum with a carcass;

FIG. 2 shows a schematic top view of a stitching roller unit according to the invention;

FIG. 3 shows a schematic top view of FIG. 2, wherein the stitching rollers have swung round; and

FIG. 4 schematically shows the movement range of one of the rollers of a pair of dynamic stitching rollers that follow the tyre contour.

### DETAILED DESCRIPTION OF THE DRAWINGS

When manufacturing a green radial pneumatic tyre use is made of a carcass drum 93 for building up or expanding thereon a carcass 92 with beads and side walls. After a belt/tread package is arranged on the carcass 92, the belt/tread package is pressed with adjustable force against the carcass 92 with the beads, the side walls and the belt/tread package by means of a stitching roller unit 1, while simultaneously rotating the carcass drum 93, so that they adhere to each other for forming the green radial pneumatic tyre that is subsequently ready for further processing.

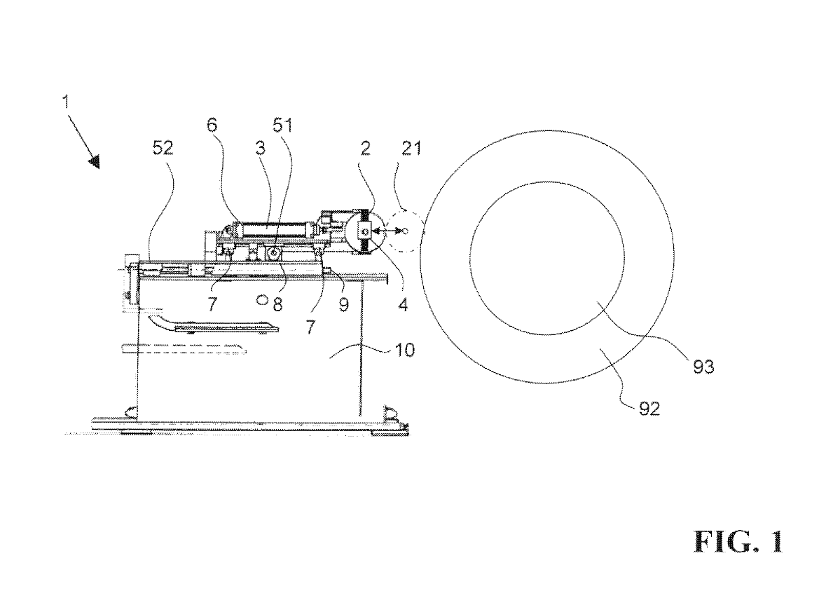

The stitching roller unit 1 can be formed by at least one stitching roller 2 as schematically shown in FIG. 1. By means of a cylinder 3 the stitching roller 2 is movable in the direction of the carcass drum 93 up into the position 21 pressing against the belt/tread package and indicated in dotted lines. The stitching roller 2 is then placed against the carcass 92 with adjustable force.

By means of the double-active stitching cylinder 3, the stitching roller 2 is retractable to the free position that is indicated in full lines.

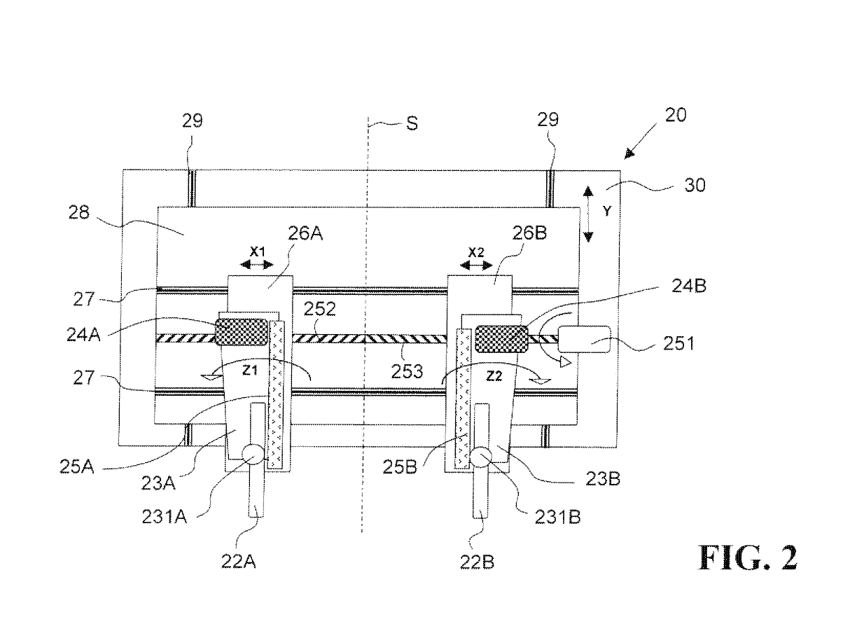

Furthermore the stitching roller 2 is provided with its individual drive mechanism 4 in the form of a motor. In the exemplary embodiment as shown in FIG. 1, the stitching roller 2 is directly placed on the driving shaft of the motor 4. In an alternative embodiment a transmission can be placed between the stitching roller 2 and the motor 4, as schematically shown in FIG. 2 and described in further detail below.

Furthermore the stitching roller unit 1 as shown in FIG. 1 is provided with a longitudinal drive 51 with which the stitching roller 2 is movable substantially in longitudinal direction with respect to the carcass drum 93, and with a radial drive 52 with which the stitching roller 2 is movable substantially in radial direction with respect to the carcass drum 93. In this exemplary embodiment said two drives 51, 52 provide a dynamic movement of the stitching roller 2 following the tyre contour.

In the exemplary embodiment of FIG. 1 the stitching roller 2 with its drive mechanism 4 and the cylinder 3 are placed on a first translation table 6. The first translation table 6 is placed on a second translation table 8 by means of two longitudinal guides 7. The second translation table 8 is placed on a support 10 by means of at least one radial guide 9. By regulating the peripheral velocity of the stitching tread of the stitching roller 2 it can be achieved that the stitching tread and an engagement position of the stitching roller 2 on the tyre 92 at least run substantially parallel.

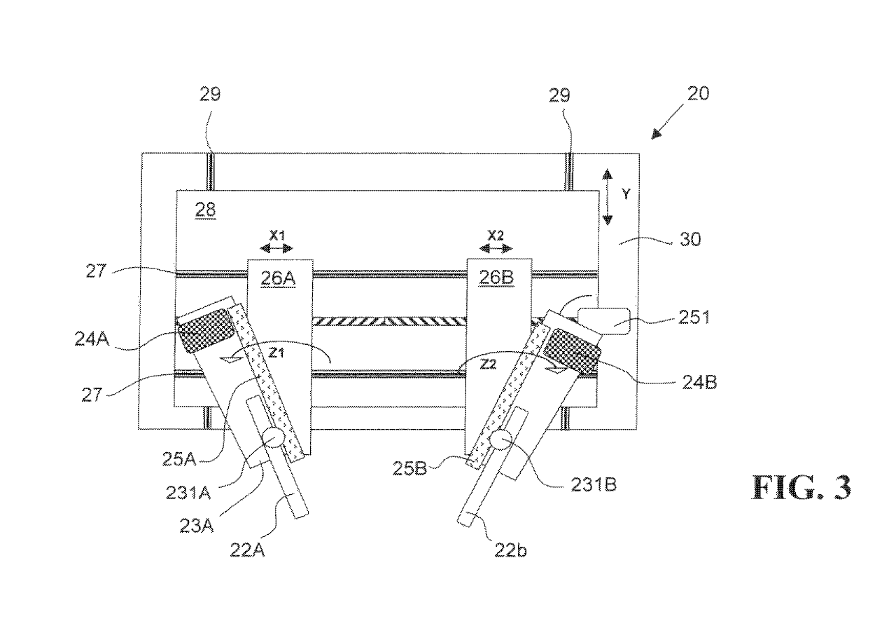

A second exemplary embodiment of a stitching roller unit 20 according to the invention is shown in the top views of FIGS. 2 and 3. Said stitching roller unit 20 comprises a pair of dynamically movable stitching rollers 22A, 22B. Each stitching roller 22A, 22B is provided with an individual drive mechanism 24A, 24B. By means of a transmission, in this example a toothed belt 25A, 25B, the drive mechanism 24A, 24B is operationally connected to the stitching roller 22A, 22B. By using a toothed belt 25A, 25B and the like, the drive mechanism 24A, 24B can be spaced apart further from the stitching roller 22A, 22B. Particularly as shown in FIGS. 2 and 3, the drive mechanism 24A, 24B is placed at a side of the stitching roller 22A, 22B corresponding with the drive mechanism 24A, 24B which side faces away from the carcass drum.

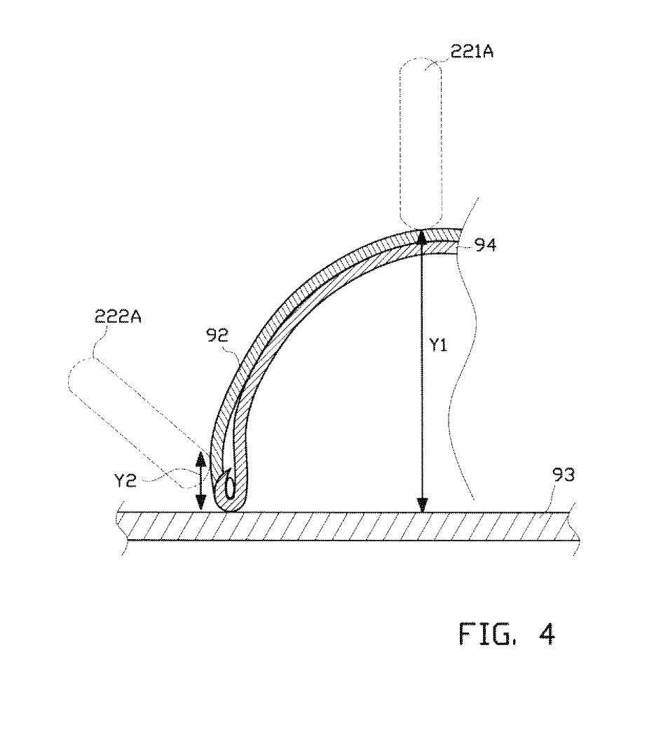

Each stitching roller 22A, 228 with its individual drive mechanism 24A, 249 is placed on its individual rotation table or centre support 23A, 23B, which around an axis of rotation 231A, 231B is rotatably connected to an individual first translation table or stitcher table 26A, 26B. Due to this construction the stitching rollers 22A and 22B can at least be swung around or rotated Z1, Z2 between a first position as shown in FIG. 2, for stitching among others the tread of the green pneumatic tyre 92, 94 as schematically shown by stitching roller 221A in FIG. 4, and a second position as shown in FIG. 3 for stitching the sides of the green pneumatic tyre 92, 94 as schematically shown by stitching roller 222A in FIG. 4.

Except that the swing angle Z1, Z2 at a longitudinal movement X1,X2 has to be adjusted for following the tyre contour, also the engagement position or contact point of the stitching roller 22A, 22B on the green pneumatic tyre 92 will come to be situated at a different distance y1 and y2 in FIG. 4, with respect to the carcass drum 93. In case of the number of revolutions of the carcass drum 93 remaining the same, the peripheral velocity at distance y1 will be greater than the peripheral velocity at distance y2. By regulating the peripheral velocity of the stitching tread of the stitching rollers 22A, 22B it can be achieved that the stitching tread and the engagement position of the stitching rollers on the tyre 92 run at least substantially parallel.

Both first translation tables or stitcher tables 26A and 26B are placed on a common second translation table or sub frame 28 by means of two longitudinal guides 27. Due to the longitudinal drive 251 the stitching rollers 22A, 22B are moveable substantially in longitudinal direction X1, X2 with respect to the carcass drum. As schematically shown in FIG. 2 the motor 251 drives a spindle that has a first part 252 for driving the first translation table 26A of the first stitching roller 22A and a second part 253 for driving the first translation table 26B of the second stitching roller 22B, wherein the pitch of the first part 252 is the opposite of the pitch of the second part 253. Preferably the size of the pitch of the first part 252 substantially equals the size of the pitch of the second part 253, as a result of which the first stitching roller 22A and the second stitching roller 22B are substantially symmetrically movable with respect to a plane a plane of symmetry S by driving the spindle by the motor 251.

The second translation table or the sub frame 28 is placed on the support or base frame 30 by means of two radial guides 29. The second translation table 28 is movable substantially in radial direction Y by means of a radial drive (not shown).

In this second exemplary embodiment the radial drive, the longitudinal drive 251 and the rotation drive of the rotation tables 23A, 23B provide a dynamic movement of the stitching rollers 22A, 22B that follows the tyre contour.

The drive mechanisms 4, 24A, 24B of the stitching rollers 2, 22A, 22B are provided with servomotors that are controlled via a control system (not shown). Preferably this control system is coupled to measuring means for determining the drive torque for driving the carcass drum.

When used, first a first value is determined for the drive torque for driving the carcass drum without a stitching roller 2, 22A, 22B contacting the carcass. Subsequently a stitching roller 2, 22A, 228 is driven by its individual motor 4, 24A, 24B and while rotating, is pressed against the carcass. As the stitching roller 2, 22A, 228 is pressed against the carcass and/or because the stitching roller 2, 22A, 22B is moved along the tyre contour, the value of the drive torque for driving the carcass drum may start deviating from the first value. The control system then regulates the motor 4, 24A, 24B of the stitching roller 2, 22A, 22B such that the value of the drive torque approaches the first value as close as possible.

The above description is included to illustrate the operation of preferred embodiments of the invention and not to limit the scope of the invention. Starting from the above explanation many variations that fall within the spirit and scope of the present invention will be evident to an expert.

Summarising the invention thus relates to an assembly and a method for manufacturing a green radial pneumatic tyre. The assembly is provided with a rotatable carcass drum for carrying a carcass with a belt/tread package for the radial pneumatic tyre and with a stitching roller unit having at least one rotatable stitching roller having a stitching tread that can be placed against the carcass and a displacement device for moving the roller radially from or towards the carcass with the belt/tread package. The stitching roller unit is provided with an individual drive mechanism for rotatingly driving the stitching tread of the stitching roller, at least without the stitching roller contacting the belt/tread package. The assembly is furthermore provided with a control device for controlling a peripheral velocity of the stitching roller, wherein the assembly comprises measuring means for determining a drive torque for driving the rotatable carcass drum or a quantity derived therefrom, and for giving a signal that is representative for the drive torque to the control device.

1. Assembly for manufacturing a green radial pneumatic tyre, which assembly is provided with a rotatable carcass drum for carrying a carcass with a belt/tread package for the radial pneumatic tyre and with a stitching roller unit having at least one rotatable stitching roller having a stitching tread that can be placed against the carcass and a displacement device for moving the roller radially from or towards the carcass with the belt/tread package, characterised in that the stitching roller unit is provided with an individual drive mechanism for rotatingly driving the stitching tread of the stitching roller, at least without the stitching roller contacting the belt/tread package, wherein the assembly is provided with a control device for controlling a peripheral velocity of the stitching roller, and wherein the assembly comprises measuring means for determining a drive torque for driving the rotatable carcass drum or a quantity derived therefrom, and for giving a signal that is representative for the drive torque to the control device.

2. Assembly according to claim 1, characterised in that the control device is adapted for controlling the peripheral velocity of the stitching roller depending on the peripheral velocity of the carcass with the belt/tread package.

3. Assembly according to claim 2, characterised in that the assembly comprises a speedometer for determining the peripheral velocity of an engagement position on the carcass and/or that the control device is adapted for calculating the peripheral velocity of the engagement position on the carcass from the number of revolutions of the carcass drum and the distance from the engagement position to the axis of rotation of the carcass drum.

4. Assembly according to claim 1, characterised in that the control device is adapted for controlling the peripheral velocity of the stitching roller depending on the signal that is representative for the drive torque.

5. Assembly according to claim 1, characterised in that the assembly comprises a servomotor for rotatingly driving the carcass drum and/or in that the drive mechanism comprises a servomotor for driving the stitching roller.

6. Assembly according to claim 1, characterised in that the stitching roller is a dynamic roller following a tyre contour, which roller is movable in a longitudinal direction with respect to the carcass drum.

7. Assembly according to claim 6, characterised in that the control device is adapted for controlling a peripheral velocity of the stitching roller depending on an engagement position on the carcass with the belt/tread package.

8. Assembly according to claim 6, characterised in that the stitching roller unit comprises one pair of dynamic stitching rollers following the tyre contour which rollers are movable in longitudinal direction with respect to the carcass drum, wherein each of both stitching rollers is provided with its individual drive mechanism.

9. Assembly according to claim 1, characterised in that the drive mechanism is spaced apart from the stitching roller, preferably at the side of the stitching roller that faces away from the carcass drum.

10. Method for manufacturing a green radial pneumatic tyre, comprising the following steps:
arranging a carcass on a rotatable carcass drum;
arranging a belt/tread package on the carcass;
rotatingly driving the carcass drum with the carcass with the belt/tread package thereon;
moving a stitching roller unit with a rotatable stitching roller towards the carcass with the belt/tread package;
stitching the belt/tread package against the carcass by the stitching roller while simultaneously rotatingly driving the carcass drum;
characterised in that, the stitching roller unit is provided with a drive mechanism for rotatingly driving a tread of the stitching roller, wherein the stitching roller is rotatingly driven before the stitching roller contacts the belt/tread package, and
in that a drive torque for driving the rotatable carcass drum or a quantity derived therefrom is determined, and a signal that is representative for the drive torque is given to a control device for controlling a peripheral velocity.

11. Method according to claim 10, characterised in that the peripheral velocity of the rotatingly driven stitching roller is set depending on a peripheral velocity of an engagement position on the carcass with the belt/tread package, where the stitching roller is about to engage or engages.

12. Method according to claim 11, characterised in that the control device directs the peripheral velocity of the stitching roller and/or the peripheral velocity of the carcass with belt/tread package, at least near the engagement position, to a substantially equal value.

13. Method according to claim 10, characterised in that a first drive torque is determined without the stitching roller contacting the belt/tread package, that subsequently a second drive torque is determined wherein the stitching roller presses against the belt/tread package, and in that the control device regulates the peripheral velocity of the stitching roller and/or the peripheral velocity of the carcass with belt/tread package such that the difference between the first and second drive torque becomes minimal.

14. Method according to claim 10, characterised in that the stitching roller is a dynamic roller following a tyre contour, which roller is moved in a longitudinal direction with respect to the carcass drum.

15. Method according to claim 14, characterised in that the control device sets the peripheral velocity of the stitching roller depending on the longitudinal movement of the stitching roller with respect to the carcass drum.

16. (canceled)
